(19) United States
(12) Patent Application Publication
(10) Pub. No.: US 2021/0318961 A1
(43) Pub. Date: Oct. 14, 2021

(54) MITIGATING POOLED MEMORY CACHE MISS LATENCY WITH CACHE MISS FAULTS AND TRANSACTION ABORTS

(71) Applicant: Intel Corporation, Santa Clara, CA (US)

(72) Inventors: Scott D. PETERSON, Beaverton, OR (US); Sujoy SEN, Beaverton, OR (US); Francesc GUIM BERNAT, Barcelona (ES)

(21) Appl. No.: 17/356,335

(22) Filed: Jun. 23, 2021

(51) Int. Cl. G06F 12/0842; G06F 12/0862

(52) U.S. Cl. CPC G06F 12/0842; G06F 2212/1024; G06F 2212/602; G06F 12/0862

(57) ABSTRACT

Methods and apparatus for mitigating pooled memory cache miss latency with cache miss faults and transaction aborts. A compute platform coupled to one or more tiers of memory, such as remote pooled memory in a disaggregated environment executes memory transactions to access objects that are stored in the one or more tiers. A determination is made to whether a copy of the object is in a local cache on the platform; if it is, the object is accessed from the local cache. If the object is not in the local cache, a transaction abort may be generated if enabled for the transactions. Optionally, a cache miss page fault is generated if the object is in a cacheable region of a memory tier, and the transaction abort is not enabled. Various mechanisms are provided to determine what to do in response to a cache miss page fault, such as determining addresses for cache lines to prefetch from a memory tier storing the object(s), determining how much data to prefetch, and determining whether to perform a bulk transfer.

### BACKGROUND INFORMATION

Resource disaggregation is becoming increasingly prevalent in emerging computing scenarios such as cloud (aka hyperscaler) usages, where disaggregation provides the means to manage resource effectively and have uniform landscapes for easier management. While storage disaggregation is widely seen in several deployments, for example, Amazon S3, compute and memory disaggregation is also becoming prevalent with hyperscalers like Google Cloud.

FIG. 1 illustrates the recent evolution of compute and storage disaggregation. As shown, under a Web scale/hyperconverged architecture 100, storage resources 102 and compute resources 104 are combined in the same chassis, drawer, sled, or tray, as depicted a chassis 106 in a rack 108. Under the rack scale disaggregation architecture 110, the storage and compute resources are disaggregated as pooled resources in the same rack. As shown, this includes compute resources 104 in multiple pooled compute drawers 112 and a pooled storage drawer 114 in a rack 116. In this example, pooled storage drawer 114 comprises a top of rack “just a bunch of flash” (JBOF). Under the complete disaggregation architecture 118 the compute resources in pooled compute drawers 112 and the storage resources in pooled storage drawers 114 are deployed in separate racks 120 and 122.

FIG. 2 shows an example of disaggregated architecture. Compute resources, such as multi-core processors (aka CPUs (central processing units)) in blade servers or server modules (not shown) in two compute bricks 202 and 204 in a first rack 206 are selectively coupled to memory resources (e.g., DRAM DIMMs, NVDIMMs, etc.) in memory bricks 208 and 210 in a second rack 212. Each of compute bricks 202 and 204 include an FPGA (Field Programmable Gate Array 214 and multiple ports 216. Similarly, each of memory bricks 208 and 210 include an FPGA 218 and multiple ports 220. The compute bricks also have one or more compute resources such as CPUs, or Other Processing Units (collectively termed XPUs) including one or more of Graphic Processor Units (GPUs) or General Purpose GPUs (GP-GPUs), Tensor Processing Unit (TPU) Data Processor Units (DPUs), Artificial Intelligence (AI) processors or AI inference units and/or other accelerators, FPGAs and/or other programmable logic (used for compute purposes), etc. Compute bricks 202 and 204 are connected to the memory bricks 208 via ports 216 and 220 and switch or interconnect 222, which represents any type of switch or interconnect structure. For example, under embodiments employing Ethernet fabrics, switch/interconnect 222 may be an Ethernet switch. Optical switches and/or fabrics may also be used, as well as various protocols, such as Ethernet, InfiniBand, RDMA (Remote Direct Memory Access), NVMe-oF (Non-volatile Memory Express over Fabric, RDMA over Converged Ethernet (RoCE), CXL (Compute Express Link) etc. FPGAs 214 and 218 are programmed to perform routing and forwarding operations in hardware. As an option, other circuitry such as CXL switches may be used with CXL fabrics.

Generally, a compute brick may have dozens or even hundreds of cores, while memory bricks, also referred to herein as pooled memory, may have terabytes (TB) or 10's of TB of memory implemented as disaggregated memory. An advantage is to carve out usage-specific portions of memory from a memory brick and assign it to a compute brick (and/or compute resources in the compute brick). The amount of local memory on the compute bricks is relatively small and generally limited to bare functionality for operating system (OS) boot and other such usages.

One of the challenges with disaggregated architectures is the overall increased latency to memory. Local memory within a node can be accessed within 100 ns (nanoseconds) or so, whereas the latency penalty for accessing disaggregated memory resources over a network or fabric is much higher.

The current solution for executing such applications on disaggregated architectures being pursued by hyperscalers is to tolerate high remote latencies (that come with disaggregated architectures) to access hot tables or structures and rely on CPU caches to cache as much as possible locally. However, this provides less than optimal performance and limits scalability.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating the recent evolution of compute and storage disaggregation;

FIG. 2 is a diagram illustrating an example of disaggregated architecture;

FIG. 3a is a diagram illustrating an example of a memory object access pattern using a conventional approach;

FIG. 3b is a diagram illustrating an example of a memory object access pattern using transaction aborts in combination with prefetches;

FIG. 4 is a schematic diagram illustrating a system in a disaggregated architecture under which a platform accesses remote pooled memory over a fabric, according to one embodiment;

FIG. 5 is a schematic diagram illustrating an overview of a multi-tier memory scheme, according to one embodiment;

FIG. 6 is a flowchart illustrating operations and logic for accessing and processing an object using a memory transaction with TX abort, according to one embodiment;

FIG. 7 is a flowchart illustrating operations and logic for accessing an object for which a cache miss page fault may occur, according to one embodiment;

FIGS. 8a and 8b respectively show flowcharts illustrating operations and logic performed during first and second passes when accessing a set of objects, according to one embodiment; and

FIG. 9 is a diagram of a compute platform or server that may be implemented with aspects of the embodiments described and illustrated herein.

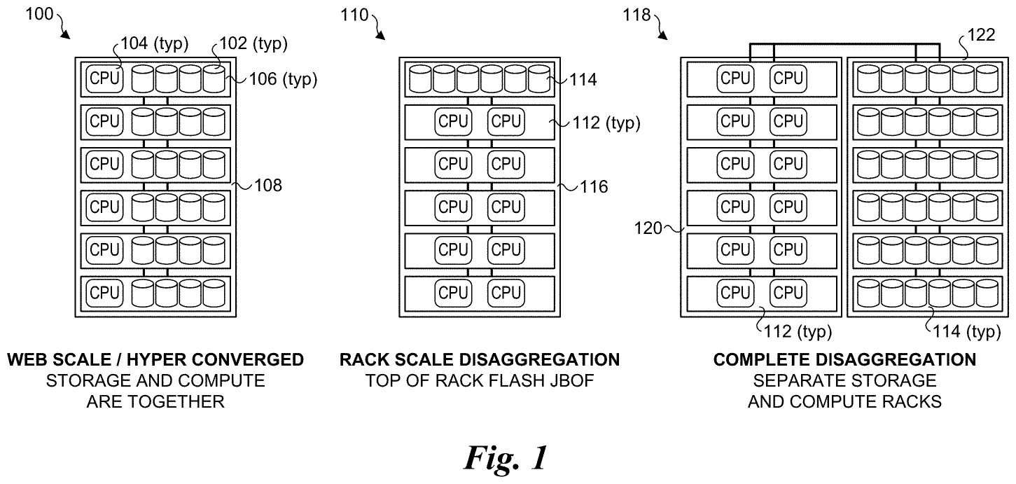

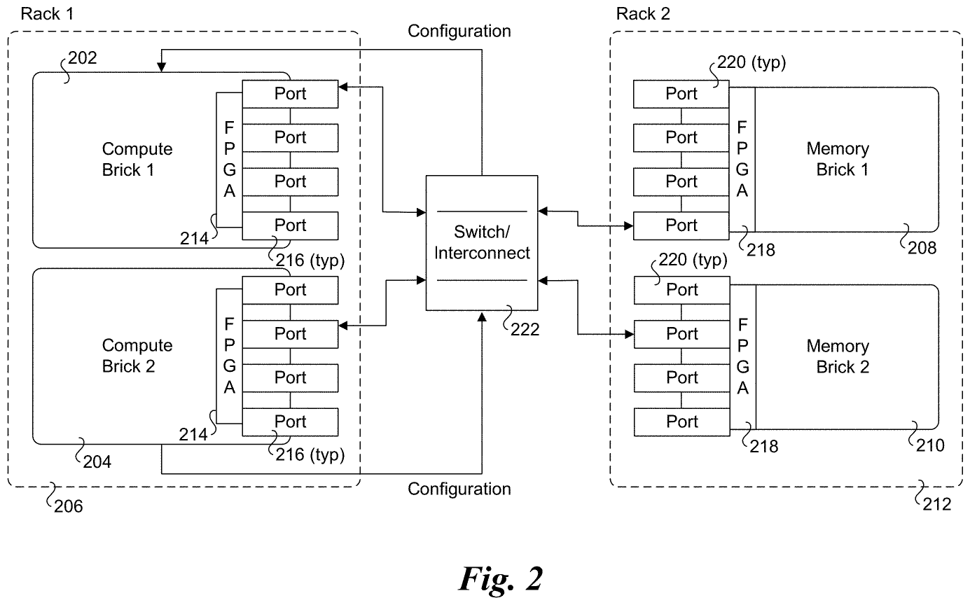

### DETAILED DESCRIPTION

Embodiments of methods and apparatus for mitigating pooled memory cache miss latency with cache miss faults and transaction aborts are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments, techniques and associated mechanisms for mitigating pooled memory cache miss latency employing cache miss faults and transaction aborts are described herein. The techniques and mechanisms help mitigate pooled memory cache misses by reducing stalls the CPU cores might normally perform while waiting for memory objects to be retrieved from remote pooled memory resources. To better understand some of the benefits, a brief discussion of existing approaches follows.

One current approach to reduce CPU stalls is to use prefetch instructions. As the name implies, prefetch instructions are used to fetch (read from memory and cache) cache lines associated with memory objects before they are to be accessed from the cache. While this approach provides some benefits, it also has limitations. Prefetch helps when the application can anticipate what it will access next, and the cache line can actually be read (meaning it must be present in the cache) before the application needs it. Algorithms that effectively use prefetch are tuned for the memory hierarchy they will run on to pipeline the memory transfers and computation on that data. These algorithms cannot adjust themselves to memory speeds that vary by multiple orders of magnitude. If the prefetched cache lines do not arrive when needed, the core will stall on a memory read.

The prefetch technique also cannot detect and exploit what is already in cache. These algorithms traverse memory in a given order based on what they think is likely to still be in cache. That may force already cached objects to be evicted before they are visited, and re-read from memory when the iterator reaches them again. While a re-read from local memory has an associated latency, this is relatively minor when compared with a re-read from a remote memory resource, such as pooled memory in a disaggregated architecture that is accessed over a fabric or network.

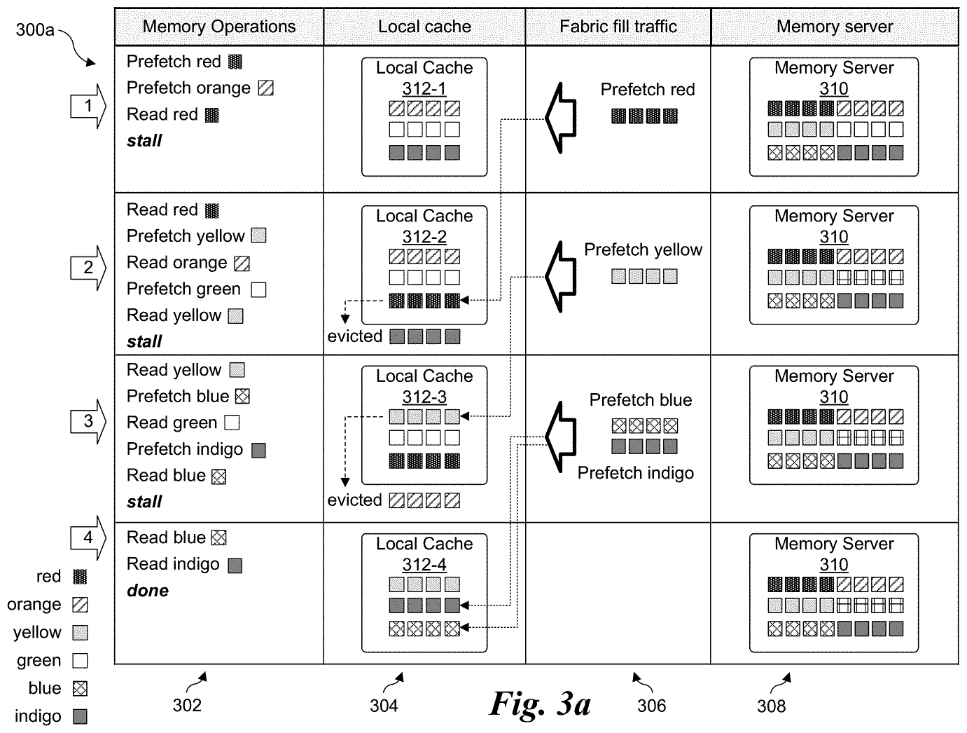

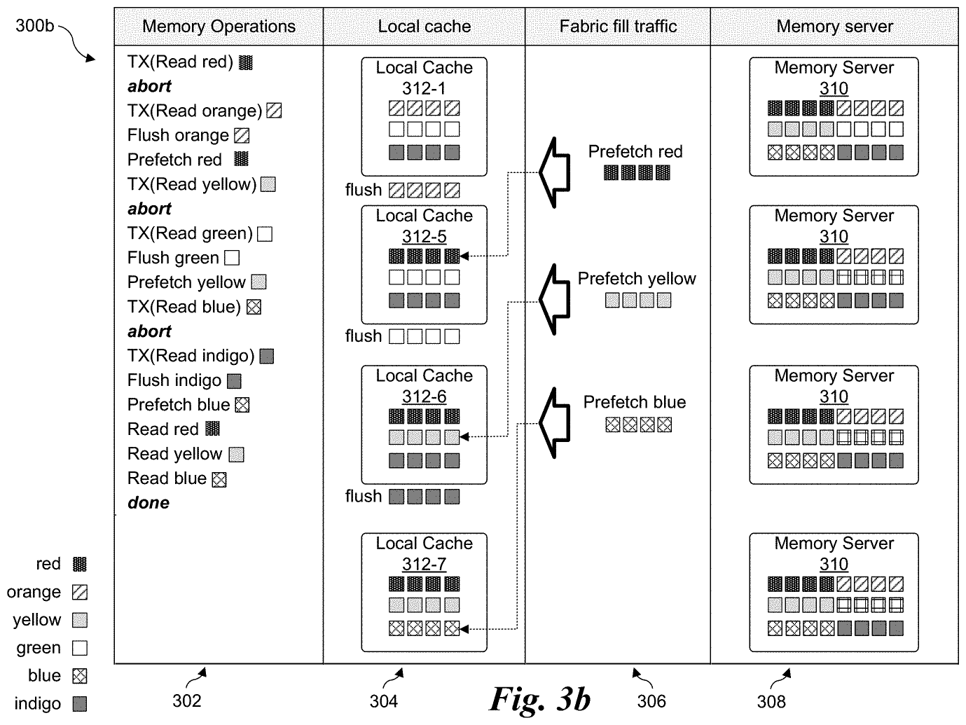

Some examples of these problems are illustrated using a table 300a in FIG. 3a. In these examples an application prefetches and accesses objects in a fixed order. Stalls due to high latency cache fills are shown, as well as the early eviction of an object visited later in the fixed order. The examples are simplified to show only a few memory operations. In practice, there would be many more memory operations performed between the illustrated prefetch operations.

The table 300a in FIG. 3a includes a memory operations column 302 listing memory operations, a local cache column 304 illustrating objects in a local cache 312, a fabric fill traffic column 306 illustrating “in flight” traffic (objects and their associated cache lines) being transferred over a fabric or the like but have yet to be written to local cache 312, and a memory server column 308 graphically illustrating various objects and cache lines stored in memory on a memory server 310 that is accessed via the fabric. Since colors cannot (generally) be included in patent drawings, the colors being referred to in FIG. 3a are represented by various crosshatch patterns and shades, as shown in the legend in the lower left-hand corner of FIG. 3a. Sets of memory operations are grouped by stages ‘1’, ‘2’, ‘3’, and ‘4’. The local cache column 304 shows the state of local cache 312 at these different stages (e.g., 312-1 for stage 1, 312-2 for stage 2, etc.). Each square represents a cache line, and each set of four squares associated with a give “color” (via the legend) represents a memory object. For simplicity, each memory object has the same size; in practice, memory objects will have different sizes and require prefetching and reading different numbers of cache lines.

In a first use context illustrated by this example, local cache represents cache lines residing in the memory hierarchy on a local host (e.g., compute platform) that is coupled to a remote memory server (310) via a fabric. A non-limiting example of a memory hierarchy includes a Level 1 (L1) cache, a Level 2 (L2) cache, and a Last Level Cache (LLC). The memory hierarchy may further include the local system memory (when applied to local cache 312). As is well-known, the processor cores in modern multi-core processors access data and instructions from L1 data and L1 instruction caches. For simplicity, the memory Read operations show cache line being read from local cache, with the transfer of data within the cache hierarchy being abstracted out.

Local cache state 312-1 shows the state of local cache 312 prior to the first stage ‘1’. The illustrative objects include an orange object, a green object, and an indigo object, each occupying four cache lines. (In an actual implementation, there would be hundreds or thousands of cache lines in a local cache, depending on the size of the local cache—the use of only a few objects in the examples herein are for simplicity and ease of understanding.) During the first stage, a “Prefetch red” memory operation is issued, followed by a “Prefetch orange” and “Read red” operation. Prefetches are used to prefetch cache lines associated with objects, wherein the software would generate one or more prefetch instructions depending on the size of the object(s). For simplicity, only a single “Prefetch [color or object]” operation is shown; In this example, each of “Prefetch red” and “Prefetch orange” would entail use of four prefetch instructions, each being used to prefetch a respective cache line.

As a result of the “Prefetch red” operation, the local cache is checked to see if the cache lines associated with the red object are present, and since they are not the prefetch operation is forwarded to memory server 310 which is storing a copy of the red object. The cache lines for the red object are Read and are sent from memory server 310 over the fabric to the local host to be stored in local cache 312.

For the “Prefetch orange” operation, the local cache will be checked, and it will be determined that the cache lines for the orange object are already present. As a result, no further operation (relating to prefetching the orange object cache lines) will ensue. When the “Read red” operation is performed, the prefetched cache lines for the red object are still in flight, and thus have not reached local cache 312. This will result in a stall, as shown.

Moving to the second group of operations ‘2’, in order to add the red objects to local cache 312, one of the sets of existing cache lines must be evicted. In this example the cache lines for the indigo object are evicted and replaced with the cache lines for the red object, which is reflected by local cache state 312-2. This enables the “Read red” object operation to be performed without stalling. Next, a Prefetch yellow memory operation is performed. This results in a miss for local cache 312 (since the cache lines for the yellow object are not present), with the prefetch operation being forwarded to memory server 310, which returns the cache lines for the yellow object and are depicted as being in flight in fabric fill traffic column 306. The “Read orange” operation does not incur a stall and the Prefetch green operation is not forwarded to memory server 310 since the cache lines for the orange and green objects are already present in local cache 312. Conversely, the “Read yellow” memory operation results in a stall since the cache lines for the yellow object are in flight and have yet to be stored in local cache 312.

Next, the third group of operations ‘3’ are performed. As before, to add the yellow object to local cache 312, one of the sets of existing cache lines must be evicted. In this case the cache lines for the orange object are evicted and replaced with the cache lines for the yellow object, which is reflected by local cache state 312-3. This enables the “Read yellow” object operation to now be performed without stalling. Next, a “Prefetch blue” operation is performed to access the blue object. This results in a miss for local cache 312 (since the cache lines for the blue object are not present), with the prefetch operation being forwarded to memory server 310, which returns the cache lines for the blue object, which are depicted as being in flight in fabric fill traffic column 306. The “Read green” operation does not incur a stall, since the cache lines for the green object are already present in local cache 312. The “Prefetch indigo” operation results in a local cache miss and is forwarded to memory server 310, which returns the cache lines for the indigo object, which are also show as in flight in fabric fill traffic column 306. Lastly, the “Read blue” memory operation results in a stall since the cache lines for the blue object are in flight and have yet to be stored in local cache 312.

As depicted for the last stage ‘4’, under local cache state 312-4 the cache lines for the blue and indigo objects have been added to the local cache (following eviction of the cache lines for the green and red objects, which are not shown). This enables the blue object and indigo object to be Read via “Read blue” and “Read indigo” operation without stalling.

Under the techniques and mechanisms disclosed in the embodiments herein, the latency problem on cache misses is mitigated using three fundamental expansions on the platform and system architecture.

First, cache miss page faults and transaction aborts work together. The cache miss page faults are handled by the OS for pages that are present, but backed by memory with much higher latency than the page fault mechanism (e.g., backed by remote pooled memory). Cache miss page faults occur in these cases where the application does not access that memory inside a TSX (Transactional Synchronization Extensions) transaction that can abort on a cache miss. Thus, a modified application will be able to react to cache misses in user mode, and the operating system can react to these cache misses when the application does not catch them.

Second, it is proposed that cacheable remote memory regions be identified to the CPU (e.g., via MTRR (memory type range register)) as regions that can produce a page fault on a cache miss. In one embodiment, this behavior is enabled per process by a bit in the per-process (e.g., per PASID (Process Address Space Identifier)) page table structure. So, the fault occurs on a cache miss only to these memory regions, and only from a process that has them enabled. These page faults will bear a new page fault error code identifying them as “cache miss faults.” An operating system (OS) handling a cache miss fault would then issue some prefetch instructions for the affected region of memory to start the cache fill. Then with the cycles that would otherwise have been spent stalled, the OS may perform local work (e.g., complete Reads from the local cache). The OS may also attempt to determine what memory the faulting process is likely to access next and prefetch that, or determine whether the process should be suspended while a more efficient bulk transfer from the memory server completes. As described below, new extensions are provided to provide hints to the OS to determine what to do.

Under the third expansion, each application that runs on the system (with a particular PASID) has an associated list of quality of service (QoS) knobs that dictate what to perform when a miss is detected under the first extension. QoS knobs include parameters such as latency and bandwidth needed to bring missed memory lines to the local cache or how much data to prefetch on a miss. In one aspect, the new quality of service logic is responsible for using platform and fabric features (such as RDT, ADQ (Application Device Queues), etc.) to ensure that data arrives in a timely manner to satisfy the provided SLAs (Service Level Agreements).

In accordance with another aspect, to ensure misses are properly mitigated, the platform exposes a new feature that allows a process to provide a simple algorithm or formula that specifies what are the next expected lines to be fetched on a memory miss. Generally, this will be mapped to certain memory ranges—e.g., the most important ones). In many cases, applications know what data will be needed depending on what is the faulting address. For applications not modified for pooled memory, the OS may learn the likely access pattern from previous cache miss page faults for that application. It may also be provided by the user, perhaps captured from the applications behavior on another machine.

These extensions provide several advantages. They enable a modified application (or the OS an unmodified application runs on) to make use of the CPU cycles that would otherwise be wasted waiting for a memory access with on the order of 10K times the latency of an L1 cache over a link with a fraction of the system's memory bandwidth. An application can use this to change the order in which it processes a set of objects, handling all those in cache or local memory before evicting anything. An OS might spend these cycles anticipating the next likely cache miss from the faulting application and either prefetching those or migrating its data with a more efficient bulk transfer.

As mentioned above, under an aspect of the embodiments cache miss page faults and transaction aborts work together to avoid wasting cycles waiting for slow and/or high latency memory. Modified applications can detect and react to cache misses for high latency memory via a new TSX transaction abort code. When applications do not catch these cache misses, the OS can via a page fault with a new page fault error code.

### Cache Miss Faults

In accordance with a first aspect of some embodiments, cacheable remote memory regions are identified to the CPUs (e.g., via MTRR) as regions that can produce a page fault on a cache miss. In one embodiment, this behavior is enabled per process by a bit in the per-process page table structure. As a result, the fault occurs on a cache miss only to these memory regions, and only from a process that has them enabled. These page faults will bear a new page fault error code identifying them as cache miss faults.

An OS handling a cache miss fault will then issue some prefetch instructions for the affected region of memory to start the cache fill. The OS now has however long it takes to fetch a cache line from the memory server to do something useful. It might make incremental progress on an OS housekeeping task like page reclaim, calling a kernel poll functions (NIC or IPC (inter-processor communication)), LRU (least recently used) updates, freeing buffers from completed operations, etc. Since paging based pooled memory is also expected to become more common, OS driven page reclaim work seems likely to increase.

For example, an OS might inspect the faulted process state to anticipate what it will access next, and prefetch that. While conceivably an OS might suspend the faulting thread, it is not expected the time required for one remote cache fill to be long enough for this approach to make sense. It might only do so for threads experiencing a series of cache miss faults. In that case a bulk transfer of memory from the memory server might be more efficient, and the OS might reschedule that thread while that bulk transfer completed.

Assuming the OS expects the faulting thread to resume doing useful work when the cache line is filled, it can resume the faulted thread as soon as that cache line fill completes. Since there's no completion signal on a cache line fill, the OS may either attempt to resume the thread when it thinks the cache line might be filled and risk faulting again, or access the memory itself at ring 0 before resuming the thread and stall the core until the cache fill completes. It could also use a TSX transaction to test for the presence of the cache line using the cache miss transaction abort feature also proposed here, and do something else useful if the transaction aborts for a cache miss.

### Cache Miss Transaction Aborts

Under embodiments herein a transaction mechanism (e.g., the TSX transaction mechanism) is extended to add the ability to abort a transaction when it would cause a cache line to be read from high latency memory. The application needs to be able to selectively enable this behavior in each transaction, and transaction aborts for cache misses need to indicate that in the abort code.

If cache miss page faults are also implemented, a transaction that can abort on a cache miss should prevent the cache miss page fault from occurring. An application prepared to react to a cache miss should not experience the overhead of a cache miss page fault.

An application modified to exploit cache miss transaction aborts when processing a set of objects too large to fit in local memory might be structured to make two passes over the objects. This is similar to Intel®'s recommended usage for the prefetch instruction. In the first pass it attempts the operation on each object in a transaction, and skips the objects that cause a cache miss transaction abort. It tracks the skipped objects, and will visit them later. It moves on to visit all the objects that are available locally, accumulating a list of those that were not available. After the first pass it will have processed everything that does not require a remote memory read. It will also not have caused any of the missing objects to be read from slow memory, so it will not have caused any of the locally present objects to be evicted to make space in the cache before it could visit them.

In the second pass, it issues prefetches for some number of the objects it skipped, and starts visiting these. This way it visits the rest of the objects, and tries to pipeline the remote memory reads with processing the objects.

An algorithm might combine these passes. After processing an object (whether it was fetched or already present) it can use a cache flush hint instruction to accelerate the flush and evict of the cache lines for that object. Shortly after that it can issue prefetches for the first object it had to skip. Now it can alternately attempt to process the next unvisited object whose location hasn't been probed, and the object it issued a prefetch for. At some point the object it skipped then explicitly prefetched will arrive, and it can be processed. After it is processed it can immediately be flushed and evicted again. This way the algorithm may be able to identify and process one or two already present objects while one it had to explicitly prefetch is in flight. It can consume the prefetched objects and evict them again, preserving the set of already present objects in local memory. That set of already present objects provides the algorithms pool of useful work to do while the other objects are transferred over the fabric.

In table 300b of FIG. 3b the algorithm from table 300a of FIG. 3a visits the same set of objects beginning with the same initial local cache state 312-1. Here, with the cache miss transaction aborts enabled, the algorithm adapts to and fully exploits the contents of its local cache 312. This approach avoids the stalls seen in table 300a, and transfers fewer cache lines over the fabric than the example in table 300a because it avoids evicting any unvisited objects in its cache.

The memory operations shown in table 300b in FIG. 3b proceed as follows. The first operation is a Read red memory transaction (TX), labeled “TX(Read red)”. In one embodiment, the transactions employ a TSX processor instruction; however, this is merely exemplary and non-limiting as other types of memory transactions and associated transaction instructions may be used. Since the cache lines for the red object are not in the local cache, the result of the “TX(Read red)” is an abort. As before, the “TX(Read [color object])” transactions shown in FIG. 3b may entail multiple TSX instructions to access the cache lines for a given object. The next operation is a “TX(Read orange)” transaction. Since the cache lines for the orange object are present in local cache 312 the read can be immediately performed, which is followed by flushing these cache lines (“Flush orange”) from the local cache. Objects (their associated cachelines) can be flushed using an associated instruction and/or hints in the source code that cause the associated instruction to be generated by the compiler. For example, some processor instruction set architectures (ISAs) support a cacheline demote instruction that demotes the cacheline to a lower-level cache (e.g., LLC) with an optional writeback to memory if the cache line is marked as Modified. Other ISA instructions effectively remove a cache line from all caches below the local memory.

The next operation is a “Prefetch red” operation. As before, this checks the local cache, resulting in a miss, with the prefetch operation being forwarded over the fabric to memory server 310. In response, the cache lines for the red object are read from memory server 310 and returned to the local host, as depicted in fabric fill traffic column 306.

The “TX(Read yellow)” operation result in an abort, since the cache lines for the yellow object are not present in local cache 312. Conversely, the next “TX(Read green)” transaction is completed since the cache lines for the green object are present in local cache 312. As above, the “Flush green” operation flushes the cache lines for the green object from local cache 312. The cache lines for the yellow object are then prefetched with the “Prefetch yellow” operation.

The next operation, “TX(Read blue)” results in an abort, since the cache lines for the blue object are not present in local cache 312. The “TX(Read indigo)” transaction is completed since the cache lines for the indigo object are present in local cache 312. As before, the “Flush indigo” operation flushes the cache lines for the indigo object from local cache 312. The cache lines for the blue object are then prefetched with the “Prefetch blue” operation.

The remaining operations “Read red,” “Read yellow,” and “Read blue” are performed by reading cachelines corresponding to the red, yellow, and blue objects that are present in local cache 312. Generally, the prefetch operations are asynchronous and cache fills resulting from a prefetch may be out-of-order relative to the prefetches, depending on various considerations such as where the fetched cache lines are read from and the latency over the fabric. For example, while memory server 310 is illustrated as storing groups of objects together, objects may be stored on different memory servers or, more generally, on the same or different pooled memory resources. Depending on competing traffic (e.g., for other tenants sharing pooled memory resources), the order that prefetch operations are effected may change relative to the order of the prefetch instructions issued from the CPU.

FIG. 3b shows four local cache states 312-1 (the initial state), 312-5, 312-6, and 312-7. In this example, the prefetches for red, yellow, and blue are returned in order (of the respective red, yellow, and blue prefetch operations). For local cache state 312-5, the “Flush orange operation” proceeds immediately, freeing cache lines associated with the flushed orange object cache lines. After being received by the host and buffered in local memory (on the host), the cachelines for the red object will be written to the local cache, as depicted by the red object having replaced the orange object in local cache state 312-5. Similar processes are performed for writing the prefetched yellow object and prefetched blue object. The “Flush green” operation will flush the cache lines for the green object, freeing them to be replaced by the cache lines for the yellow object, as shown in local cache state 312-6. Similarly, the “Flush indigo” operation will flush the cache lines for the indigo object, freeing them to be replaced by the cache lines for the blue object, as shown in local cache state 312-7.

As compared with the conventional approach shown in FIG. 3a, all stalls on slow memory are avoided under the novel TX abort scheme of FIG. 3b. This provides significant benefit, especially when access memory tiers with high latency such as remote pooled memory

### Cache Miss Aborts without Remote Memory

These mechanisms disclosed herein may be useful for data parallel libraries even without remote memory. For example, the larger the CPU cache, and the larger the latency difference between L1 and main memory, the more benefit the mechanisms have. Data parallel libraries may use these mechanisms to operate on data items actually still in cache first and defer the rest. They could do this collaboratively on a few strategically chosen cores in a few different places in the cache hierarchy to avoid as much memory traffic as possible. Again, the more cache there is in each domain the more benefit this approach has.

These algorithms exploiting multiple caches might benefit from using the accelerator user mode work queueing mechanisms (e.g., hardware FIFOs) between each thread to coordinate visiting each object only once. They could arrange themselves in a ring of these hardware FIFOs (or a version of them that worked between software threads), and pass the addresses of the objects skipped by the ringleader along the chain until one of the threads finds the object in cache.

Both the cache miss page fault and abort are described here as occurring without triggering a cache fill. This enables the application or OS to avoid evicting anything, and decide whether to fill that cache line now or later. In the case of the cache miss page fault, waiting for the OS to start the cache fill will significantly delay its completion. Either of these mechanisms might benefit from the ability to specify whether they trigger a cache fill or not before aborting or faulting.

### Quality of Service

In accordance with additional aspects of some embodiments, mechanisms for supporting QoS are provided. In one embodiment, each application that runs on the system (with a particular PASID) has an associated a list of quality of service knobs that dictate what to perform when a miss is detected.

To support QoS, the platform exposes a first new interface to allow the software stack to specify QoS knobs that include QoS requirements such latency and bandwidth needed to bring missed memory lines to the local machine or how much data to prefetch on a miss. In one embodiment, the new interface includes:
The PASID associated to the process to whom the quality of service is attached.
The quality of service metric and KPI (key performance indicator). In one embodiment the following potential metrics and KPIs are supported:
   Latency bound to the process of the page miss.
   Amount of subsequent memory lines that need to be brought from the remote memory and the associated bandwidth.
Whether the service level agreement is a soft or hard service level agreement.

The platform exposes a second new interface that enables an application or user to provide a simple algorithm or formula that specifies what are the next expected lines to be fetched on a memory miss. In many cases, applications know what data will be needed depending on what is the faulting address. Hence, the idea is the platform allows the software stack to provide hints. In one embodiment a hint is defined by:
The memory address range that belongs to the hint.
The actual hint that is a function or algorithm that can run in an ARM or RISC processor that will generate the subsequent addresses to fetch. This will be tightly integrated into the QoS knobs.

The new quality of service logic is responsible to use platform and fabric features (RDT, ADQ, etc.) to ensure that data arrives satisfying the provided SLAs. Based on the previous interfaces the logic will allocate applicable end-to-end resources from the CPU to the memory pool.
RDT on the local memory, LLC and IO (Input-Output) of the platform.
Configuring NIC resources (such as ADQ and virtual queues) to be sure there is enough BW to the remote node.
Configuring virtual lanes on the fabric to be lanes on the fabric to allocate/reserve sufficient bandwidth for each PASID to meet its SLA.

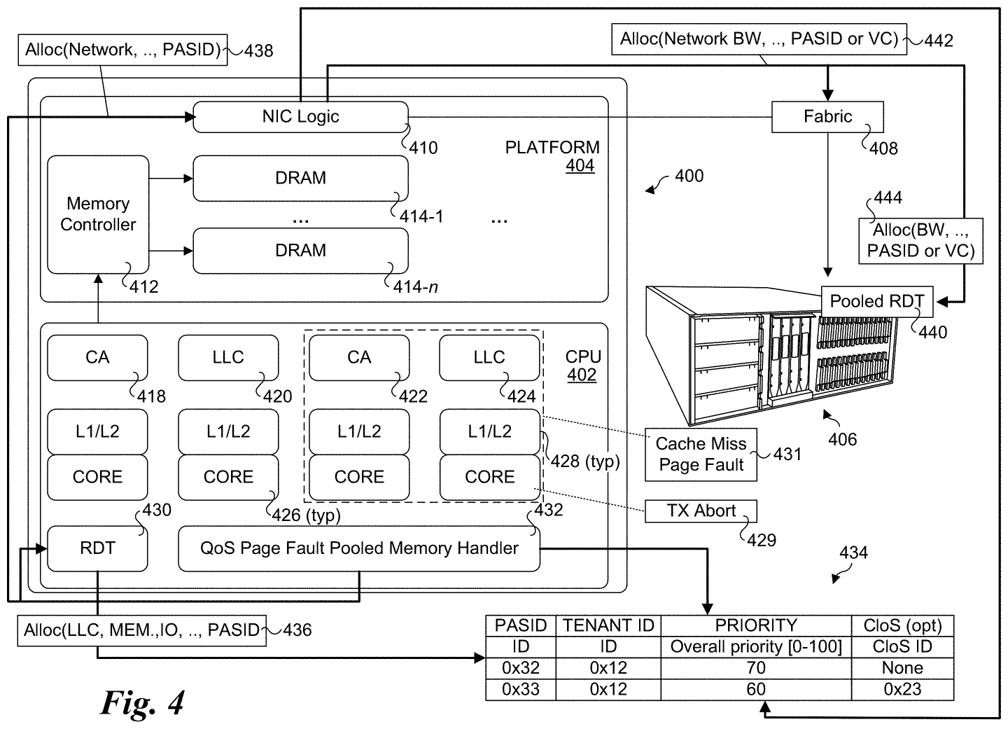

FIG. 4 shows a high-level view of a system architecture according to an exemplary implementation of a system in which aspects of the foregoing mechanisms may be implemented. The system includes a compute platform 400 having a CPU 402 and platform hardware 404 coupled to pooled storage 406 via a network or fabric 408. Platform hardware 404 includes NIC logic 410 (e.g., logic for implementing NIC operations including network/fabric communication), a memory controller 412, and n DRAM devices 414-1 . . . 414-n. CPU 402 includes caching agents (CAs) 418 and 422, LLCs 420 and 424, and multiple processor cores 426 with L1/L2 caches 428. Generally, the number of cores may range from four upwards, with four shown in the figures herein for simplicity.

In some embodiments, CPU 402 is a multi-core processor System on a Chip with one or more integrated memory controllers. Generally, DRAM devices 414-1 . . . 414-n are representative of any type of DRAM device, such as DRAM DIMMs and Synchronous DRAM (SDRAM) DIMMs. Further examples of memory devices and memory technologies are described below.

One or more of cores 426 includes TX abort logic 429, which is used to implement the hardware aspects of TX aborts described herein. In one embodiment, TX abort logic 429 is used to tag each memory access from any instruction with the ID of the memory tier the will be waited for, and includes some more logic to check for memory accesses that failed because they missed cache at that level. In one embodiment, this includes logic to determine what memory tier constraint to apply (if any) to memory accesses initiated by each instruction. If cache miss page faults are enabled for the PASID the core is executing, the memory tier constraint comes from that. If the core executes an XBEGIN that specifies a memory tier to abort on, that becomes the memory tier used in subsequent memory accesses until the TX ends or aborts (unless cache miss TX aborts are disabled for this process, in which case the core aborts the TX now and the tier constraint from the XBEGIN is never used). When a memory access fails because it missed cache at the specified level, the instruction(s) that triggered the memory access will trigger a cache miss indication when (/if) it is executed. If the memory tier used in the failed memory access came from a TX, the TX aborts with this cause. Otherwise, the core takes a page fault with this error code. The new logic prepares the core to receive cache miss indications, and then pass that to software via a page fault or a TX abort.

CPU 402 also includes cache miss page fault logic 431, which may be implemented in a core or may be implemented via a combination of a core and caching agents associated with the L1/L2 and LLC. For example, for a data access instruction executed on a core the specifies a cache line address, the logic will check the L1 cache for that cache line. If that cache line is not present, the CA for the L1 cache (or for the L1/L2 cache) will check to see if the line is present in the L1 cache. If the cache line is not present in either L1 or L2, CAs for L1/L2 or L2 will coordinate with a CA for the LLC to determine if the line is present in the LLC. The caching agents then coordinate (as applicable) copying of the cache line into the L1 cache or provide an indication the cache line is not present.

As discussed herein, the definition of a local cache miss may vary depending on what “local cache” encompasses. In some embodiment, local cache may mean L1/L2, while in other embodiments, local cache may mean L1/L2+LLC. For embodiments using a 2LM scheme, a local cache may correspond to memory in a nearest memory tier. In such instances, the cache miss indication logic is implemented in the memory tier interface rather than in the CPU. Upon receiving that cache miss indication from the memory interface, the CPU will cause a TX abort or page fault as in [0069].

CPU 402 further includes RDT logic 430, and QoS page fault pooled memory handler logic 432. In one embodiment, RDT logic 430 performs operations associated with Intel® Resource Director Technology. RDT logic 430 provides a framework with several component features for cache and memory monitoring and allocation capabilities. These technologies enable tracking and control of shared resources, such as LLC and main memory (DRAM) bandwidth, in use by many applications, containers or VMs running on the platform concurrently.

QoS page fault pooled memory hander logic 432 enables system 400 to implement QoS aspects in connection with page faults when requested cache lines are missed and need to be accessed from pooled memory. This includes accessing a QoS table 434 including identifiers (IDs) and parameters that are implemented to effect QoS requirements to meet SLAs. RDT 430 allocates resources in a block 436, such as LLC, memory, Input-Output (IO), to applications based on PASIDs. RDT logic 430 allocates network resources including network bandwidth (BW) with associated PASIDs to NIC logic 410, as shown in a block 438. In one embodiment RDT 430 is also used to populate QoS table 434; optionally, a separate configuration tool (not shown) may be used for this. NIC logic 410 allocates network bandwidth and other network or fabric parameters to fabric 408 and pooled RDT logic 440, as shown by blocks 442 and 444. The network bandwidth and other network or fabric parameters may be allocated using a PASID or a virtual channel (VC). Pooled RDT logic 440 is configured to perform RDT-type function as applied to pooled memory 406.

The IDs and parameters in QoS table 434 include a PASID, a Tenant ID, a priority, and an optional class of service (CloS) ID. In addition to what is shown, QoS table or a similar data structure may further provide parameters for providing other QoS constraints and/or parameters.

### Application to Multi-tiered Memory Architectures

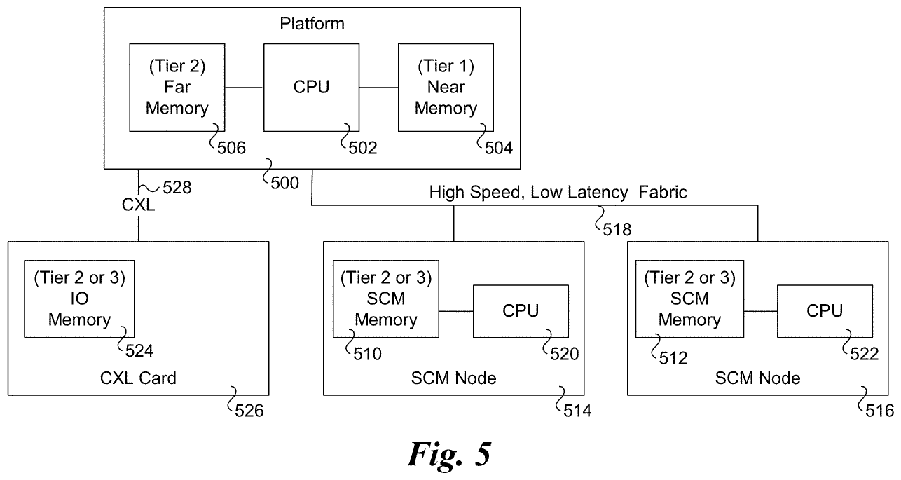

The teachings and the principles described herein may be implemented using various types of tiered memory architectures. For example, FIG. 5 illustrates an abstract view of a tiered memory architecture employing three tiers: 1) “near” memory; 2) “far” memory; and 3) SCM (storage class memory). The terminology “near” and “far” memory do not refer to the physical distance between a CPU and the associated memory device, but rather the latency and/or bandwidth for accessing data stored in the memory device.

FIG. 5 shows a platform 500 including a central processing unit (CPU) 502 coupled to near memory 504 and far memory 506. Compute node 500 is further connected to Storage Class Memory (SCM) memory 510 and 512 in SCM memory nodes 514 and 516 which are coupled to compute node 500 via a high speed, low latency fabric 518. In the illustrated embodiment, SCM memory 510 is coupled to a CPU 520 in SCM node 514 and SCM memory 512 is coupled to a CPU 522 in SCM node 516. FIG. 5 further shows a second or third tier of memory comprising IO (Input-Output) memory 524 implemented in a CXL (Compute Express Link) card 526 coupled to platform 500 via a CXL interconnect 528.

Under one example, Tier 1 memory comprises DDR and/or HBM, Tier 2 memory comprises 3D crosspoint memory, and T3 comprises pooled SCM memory such as 3D crosspoint memory. In some embodiments, the CPU may provide a memory controller that supports access to Tier 2 memory. In some embodiments, the Tier 2 memory may comprise memory devices employing a DIMM form factor.

To support a multi-tier memory architecture, the MTRR mechanism described here would be extended to include several classes of memory bandwidth and latency. The XBEGIN instruction argument to enable aborts on cache misses would similarly grow to include a mask or enum to specify which memory classes cause an abort. For example, instead of one bit in the TSX abort code for cache miss, there would be one bit per memory class. The per (OS) thread cache miss page fault enable mechanism would also gain a mask like this to select which memory classes warranted the overhead of a page fault on a miss.

An application would identify all the memory classes and their characteristics from something the OS provides. It would decide based on those properties which ones it wanted to catch itself, and generate its XBEGIN argument based on that. When the application catches a TSX abort it can tell from the abort code which memory class it tripped on, and from the memory class properties how long a fill from that memory would take. The application can then decide whether to attempt to pipeline the fills and flushes, ask the OS to do it, or ship the function in question to the memory instead.

In one embodiment, when QOS is implemented, the application is enabled to tell from the memory class that aborts the transaction and the QOS stats for itself provided by the OS (and hardware) whether requesting a cache fill from this memory would exceed its quota for this time quanta. The application may decide to do something else rather than request that cache fill, such as issue prefetches, as described above with reference to FIG. 4.

In one embodiment the TX abort code includes a “QOS exceeded” flag. Thus, the application does not need to look at the RDT stats after a TX abort to decide what to do. In one embodiment, the QoS mechanisms are configured to indicate an estimated fetch latency based on memory class, QOS stats, and (optionally) observed performance in the fabric interface.

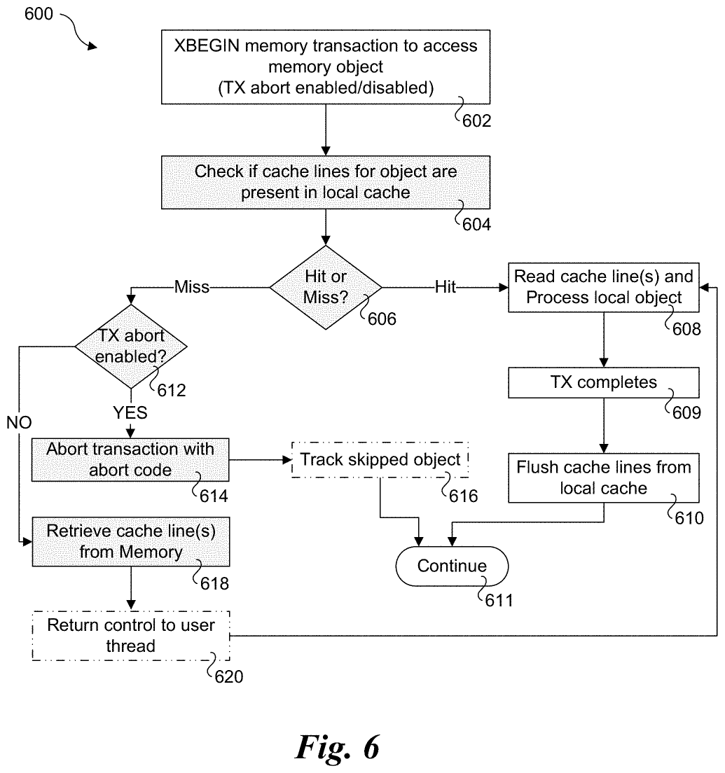

FIG. 6 shows a flowchart 600 illustrating operations and logic for accessing and processing objects, according to one embodiment. In FIGS. 6, 7, 8a, and 8b, blocks with a solid line and white background are performed by an application, blocks with a gray background are performed by hardware, and blocks with a dash-dot-dot line are performed by an operating system. Blocks with a dashed line are optional. The process begins in a block 602 with a XBEGIN memory transaction to access the memory object. Generally, depending on the size of the object, the object may be stored in one or more cache lines. In a block 604 a check is made to detect whether the cache lines for the object are present in local cache. A decision block 606 indicates whether the cache lines are present (a “Hit”) or missing (a “Miss). In one embodiment, if any of the cache lines are not present the result is a Miss. Various approaches may be used to determine whether all the cache lines for the object are present such as reading a byte from each of the object's cache lines in a TX, or (for larger objects) reading a byte from the object's cache lines a few at a time in a series of transactions, or (if the operation will touch a small subset of the object's cache lines) read a byte from each of the cache lines the operation will actually touch (e.g. the ones containing specific fields of the object), or (if the operation on the object is very simple) just attempting to process the object inside a TX without testing the cache lines for presence (if the operation completes without aborting the TX, those cache lines were present).

If the cache lines are present in the local cache, the answer to decision block 606 is “Hit” and the logic proceeds to perform the operations in blocks 608, 609, and 610. These operations are shown in dashed outline to indicate the order may differ and/or one or more of the operations may be optional under different use cases. As shown in block 608, the cache lines are read from the local cache and the local object is processed. The transaction completes in block 609. Depending on whether the object is to be retained, the cache lines may be flushed from the local cache, as shown by an optional block 610. For example, if it is known that the object will be access once and will not be modified, the cache lines for the object may be flushed, as there would be no need to retain them. Following the operations of blocks 608, 609, and 610, the process continues as depicted by a continue block 611.

As explained below, in some cases it may be desired to ensure that multiple objects are in the local cache before processing one or more of the objects. Under one embodiment, the operation of block 608 will be skipped and the TX will complete. As an option, a mechanism such as a flag may be used to indicate to the software the object is present in the local cache and does not need to be prefetched.

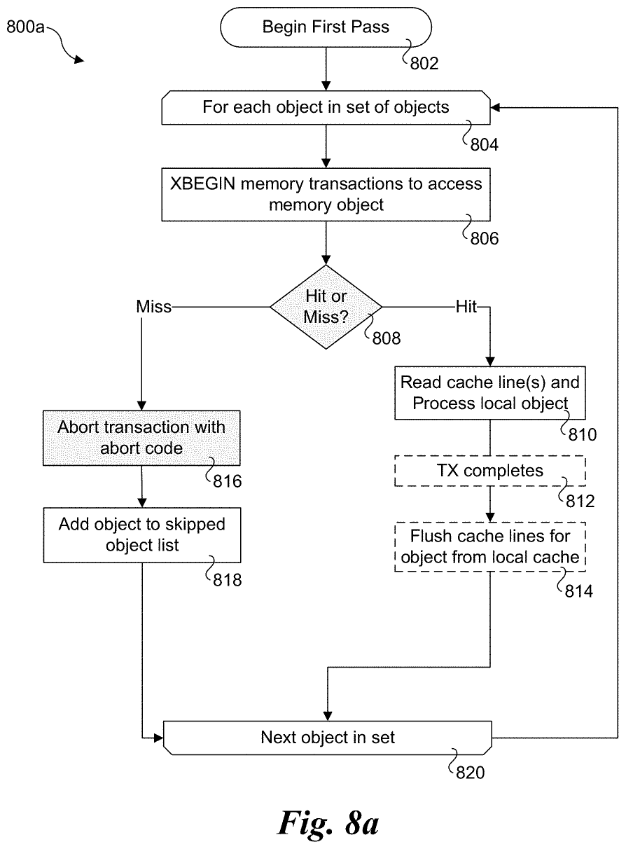

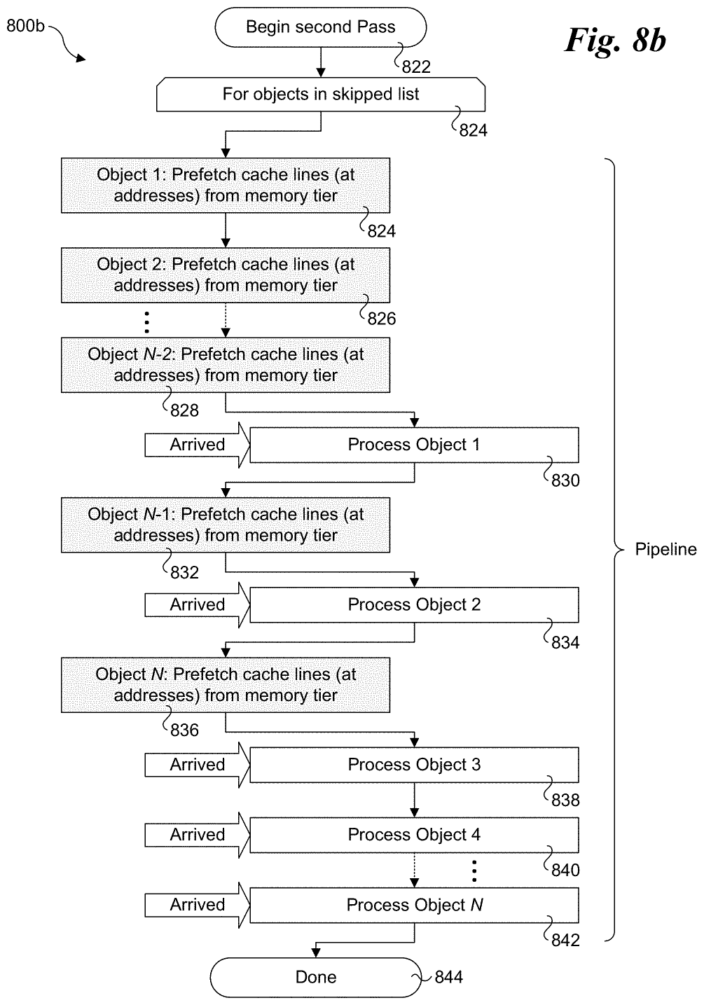

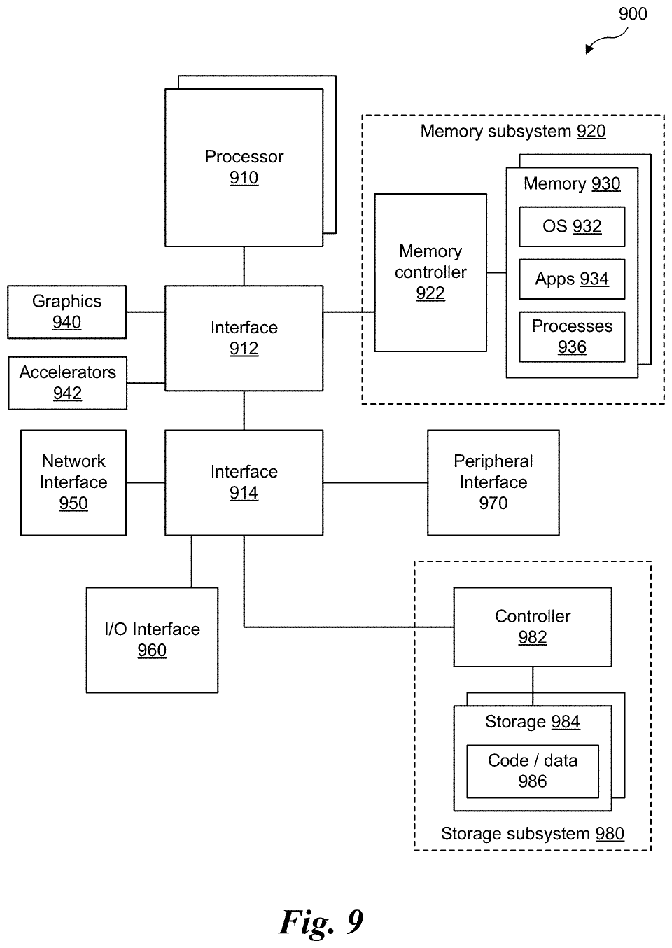

Returning to decision block 606, if the result is a Miss, the logic proceeds to a decision block 612 in which a determination is made to whether a TX abort is enabled. As discussed above, in one embodiment TX abort may be enabled per TSX transaction. If TX abort is enabled, the logic proceeds to a block 614 in which the transaction is aborted with an abort code. In a block 616 the skipped object is tracked or otherwise a record indicating the object caused a TX abort is made. In some embodiments, such as described below with reference to FIGS. 8a and 8b, objects for which transactions are aborted are tracked as skipped objects, as shown in a block 616. The logic then proceeds to continuation block 611.

For local cache misses for cases in which TX abort is not enabled for the memory transaction, conventional TX processing takes place. This includes retrieving the cache line(s) from memory in a block 618 and returning control to the user thread in a block 620. The logic then proceeds to block 608 to read the cache line(s) (now in the local cache) and process the local object.

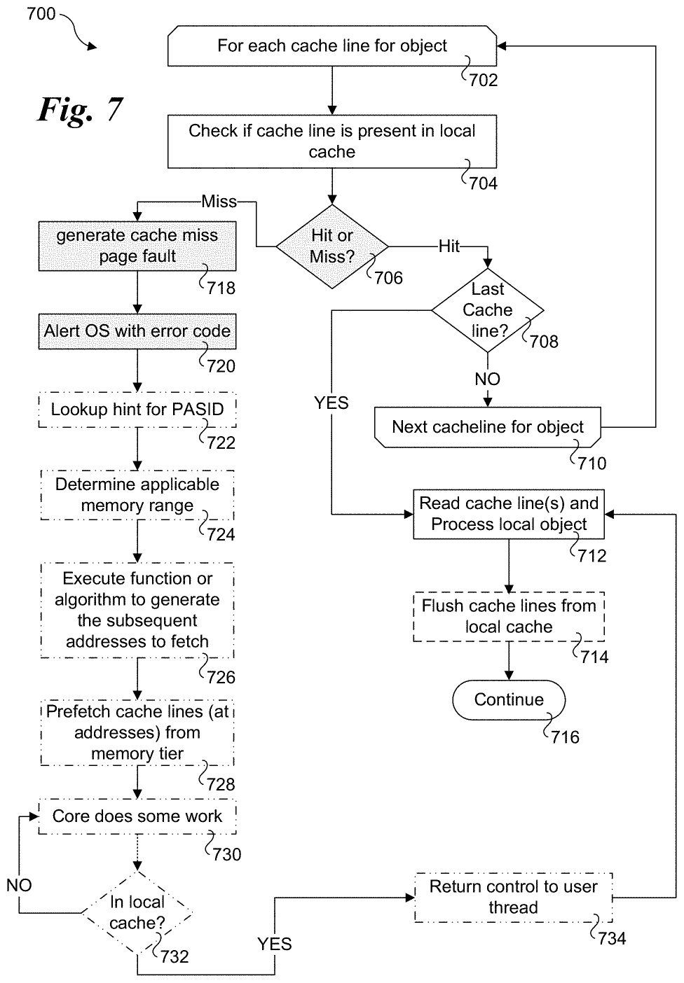

FIG. 7 shows a flowchart illustrating operations and logic for accessing an object for which a cache miss page fault may occur, according to one embodiment. In this example it is presumed the memory object being accessed is stored at a page (e.g., memory address range) for which cache miss page faults are registered or otherwise enabled. As shown in a start loop block 702, the following operations are performed for each cache line that is accessed for the object. In a block 704 a check is made to determine if the cache line is present in the local cache. As shown in a decision block 706, this will result in a Hit or Miss. If the result is a hit, a determination is made in a decision block 708 to whether the cache line is the last cache line for the object. If the answer NO, the logic loops back to process the next cache line.

Once all the cache lines for the object are confirmed to be in the local cache, the answer to decision block 708 is YES, and the logic proceeds to a block in which the cache line(s) for the object are read from local cache and the object is processed. In an optional block 714 the cache lines are flushed from the local cache, with the criteria whether to flush or not being similar to that described above for block 610 in FIG. 6. The process then continues to process a next object or to perform other operations, as depicted by a continue block 716.

Returning to decision block 706, if the cache check results in a Miss, the logic proceeds block 718 in which a cache miss page fault is generated. In response to detection of the cache miss page fault, in a block 620 the hardware sends an alert to the operating system with an error code. In a block 722, a hint for the process is looked up using the process PASID. In a block 724, an applicable memory range is determined, and in a block 726 a function or algorithm is executed to generate a set of subsequent addresses to fetch.

Next, the OS performs a set of operations to prefetch the object and verify the cachelines have been copied to the local cache. In a block 728, the cache line(s) for the object are prefetched at the address(es) generated in block 726 from an applicable memory tier. For example, in one embodiment the memory tier may comprise remote pooled memory. In another embodiment, the memory tier may be a local memory tier, such as a second memory tier in a three-tier architecture. In some cases, the memory tier could be local memory, with the local cache designed as tier 0 and the local memory (e.g., primary system DRAM) being designated as tier 1. Prefetching cachelines is an immediate operation from the perspective of the core executing the instructions, but the cache lines will not be available for access from the local cache until they have been retrieved from their memory tier. During this transfer latency, the core may do some other work in a block 730, such as some kernel work. As depicted in a decision block 732, the OS will determine when the cache lines are available in the local cache. Various mechanisms may be used for this determination, such as polling or using a separate thread to perform the check and have the OS notified when the cache lines are available. Once they are available, control is returned to the user thread in a block 734. The application then takes over processing, with the logic looping back to blocks 712, 714 and 714.

In some embodiments, the operations of blocks 722, 724, and 726 may be of offloaded from the process thread. For example, these operations might be offloaded by execution of instructions on an embedded processor or the like that is separate from the CPU cores used to execute the process. Optionally, a separate core may be used to perform the offloading, or otherwise the offloading may be performed by executing a separate thread on the same core as the main process.

In the foregoing description it is presumed that a memory region in which the object is stored is registered for cache miss page faults. A cache miss for a non-registered region (and for which TX abort was not enabled for the transaction) would be handled in the normal manner, such as reading the cache line(s) from system memory. If the object was in memory at a tier lower than system memory (farther away in terms of latency), then some mechanism would be used to access the object from that memory.

In flowchart 700, a check is made to see that the entire object is in the local cache before accessing the object (reading the cache lines for the object in the local cache). This is merely one exemplary approach. In another approach the cache lines that are available may be read from the local cache and if any cache lines are missing when a first of the missing cache lines is detected (in decision block 706) the prefetch logic may identify only the cache lines that are not present in the local cache and prefetch those cache lines. (Optionally, other cache lines may be prefetched, such as for processes that will be working on multiple objects.) Generally, if consistent flushing is used, either none or all of the cache lines for an object will be present in the local cache, and the logic illustrated in flowchart 700 will apply.

FIGS. 8a and 8b respectively show flowcharts 800a and 800b illustrating operations and logic performed during first and second passes when accessing a set of objects. In this example it is presumed that TX abort is enabled for the memory transactions. The process for the first pass begins in a start block 802. As shown by the start and end loop blocks 804 and 820 the operations and logic in block 806, decision block 808, and blocks 810, 812, 814, 816, and 818 are performed for each object in the set of objects.

In block 806 a transaction XBEGIN is used to begin accessing the cache lines for the object. In decision block 808 a determination is made whether there is a Hit or Miss for the local cache. If the cache lines for the object are present in the local cache, the cache lines are read and the local object is processed in block 810. This also completes the TX, as shown in a block 812. In optional block 812 the cache lines for the object are flushed from the local cache. The logic then proceeds to end loop block 720 and loops back to start loop block 706 to work on the next object. The order of operations 810, 812, and 814, may vary and/or not all of these operations may be performed.

If there is a Miss, the logic proceeds to block 816 in which the transaction is aborted with an abort code. The object is then added to a skipped object list in a block 818, with the logic proceeding to loop back to XBEGIN transactions for the next object. The result of this first pass is that local objects will have been available and processed, while unavailable (e.g., not in the local cache) objects will be added to the skipped object list.

Now referring to flowchart 800b in FIG. 8b, the second pass begins in a start block 822. As depicted by a block 824, the remaining operations are performed for the objects in the skipped object list. As discussed above, in one embodiment the operations during the second pass are pipelined such that the thread does not stall waiting for prefetched objects to be available in the local cache. Generally, the pipelined operations may be implemented via a single thread, or multiple threads may be used (such as using one thread to prefetch and the second thread to process the objects once they are available in the local cache).

For this example, there are N objects 1, 2, . . . N-2, N-1, and N, where N is an integer that varies in size. In block 824, 826, and 828, objects 1, 2, and . . . N-1 are prefetched from their memory tier. For example, the memory tier could be a remote pooled memory tier or might be a local memory tier. During the prefetch operation in block 828, objects 1 . . . N-1 will be in flight to the local cache. In this example it is presumed that at a block 830 object 1 has been copied into the local cache. Various mechanisms may be used to inform the application that an object has “arrived” (meaning the object's cache lines have been copied to the local cache). Once an object has arrived, the object can be processed. Thus, in block 830 object 1 is processed. In blocks 832 and 836 objects N-1 and N are prefetched, while objects 2, 3, 4 . . . N are processed in block 834, 838, 840, and 842. Following the processing of object N (the last object), the process is complete, as depicted by an end block 844.

As discussed above, from the perspective of a core the prefetch operations are performed immediately. Thus, depending on the number and size of the objects to be prefetched, all the prefetched operation might be performed before any of the objects arrive in the local cache. In this case, the core may perform other operations while the objects are in flight.

### Example Platform/Server

FIG. 8 depicts a compute platform or serve 800 (hereinafter referred to compute platform 800 for brevity) in which aspects of the embodiments disclosed above may be implemented. Compute platform 800 includes one or more processors 810, which provides processing, operation management, and execution of instructions for compute platform 800. Processor 810 can include any type of microprocessor, central processing unit (CPU), graphics processing unit (GPU), processing core, multi-core processor or other processing hardware to provide processing for compute platform 800, or a combination of processors. Processor 810 controls the overall operation of compute platform 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute platform 800 includes interface 812 coupled to processor 810, which can represent a higher speed interface or a high throughput interface for system components that needs higher bandwidth connections, such as memory subsystem 820 or optional graphics interface components 840, or optional accelerators 842. Interface 812 represents an interface circuit, which can be a standalone component or integrated onto a processor die. Where present, graphics interface 840 interfaces to graphics components for providing a visual display to a user of compute platform 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

In some embodiments, accelerators 842 can be a fixed function offload engine that can be accessed or used by a processor 810. For example, an accelerator among accelerators 842 can provide data compression capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of compute platform 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in compute platform 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for compute platform 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

While not specifically illustrated, it will be understood that compute platform 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute platform 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides compute platform 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Various embodiments can be used in connection with network interface 850, processor 810, and memory subsystem 820.

In one example, compute platform 800 includes one or more I/O interface(s) 860. I/O interface 860 can include one or more interface components through which a user interacts with compute platform 800 (e.g., audio, alphanumeric, tactile/touch, or other interfacing). Peripheral interface 870 can include any hardware interface not specifically mentioned above. Peripherals refer generally to devices that connect dependently to compute platform 800. A dependent connection is one where compute platform 800 provides the software platform or hardware platform or both on which operation executes, and with which a user interacts.

In one example, compute platform 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (i.e., the value is retained despite interruption of power to compute platform 800). Storage 884 can be generically considered to be a “memory,” although memory 830 is typically the executing or operating memory to provide instructions to processor 810. Whereas storage 884 is nonvolatile, memory 830 can include volatile memory (i.e., the value or state of the data is indeterminate if power is interrupted to compute platform 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014), HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of compute platform 800. More specifically, power source typically interfaces to one or multiple power supplies in compute platform 800 to provide power to the components of compute platform 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, compute platform 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, CXL, HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

The use of the term “NIC” herein is used generically to cover any type of network interface, network adaptor, interconnect (e.g., fabric) adaptor, or the like, such as but not limited to Ethernet network interfaces, InfiniBand HCAs, optical network interfaces, etc. A NIC may correspond to a discrete chip, blocks of embedded logic on an SoC or other integrated circuit, or may be comprise a peripheral card (noting NIC also is commonly used to refer to a Network Interface Card).

While some of the diagrams herein show the use of CPUs, this is merely exemplary and non-limiting. Generally, any type of XPU may be used in place of a CPU in the illustrated embodiments. Moreover, as used in the following claims, CPUs and all forms of XPUs comprise processing units.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented with a compute platform including a local memory cache operatively coupled to one or more memory tiers, comprising:
executing, via a processor on the compute platform, a memory transaction to access a first object;
determining the first object is not in the local memory cache, and in response,
determining a transaction abort is enabled for the memory transaction; and
aborting the memory transaction.

2. The method of claim 1, further comprising:
determining a memory tier in which the first object is present; and
prefetching the first object from that memory tier.

3. The method of claim 1, further comprising:
executing, via the processor, instructions to access a second object;
determining the second object is not in the local memory cache, and in response,
generating a cache miss page fault.

4. The method of claim 3, wherein the instructions are executed by a process, further comprising:
in response to the cache miss page fault,
determining one or more actions to take, wherein the actions to take are associated with a process identifier for the process.

5. The method of claim 4, wherein the one or more actions to take comprises employing a function or algorithm to generate one or more addresses of cache lines to prefetch from the memory tier.

6. The method of claim 5, wherein the instructions are executed on a processor core in a central processing unit (CPU) of the processor; and wherein the function or algorithm is executed on a processing element that is separate from the processor core.

7. The method of claim 3, further comprising identifying cacheable regions in one or more memory tiers to the processor as regions that can produce a page fault on a local cache miss.

8. The method of claim 7, wherein a cache miss page fault may only occur in response to execution of one or more instructions attempting to access a cacheable region.

9. The method of claim 1, further comprising implementing Quality of Service (QoS) parameters for respective applications and/or processes, wherein the QoS parameters dictate one or more operations to perform in response to a local cache miss.

10. The method of claim 9, wherein the QoS parameters includes indicia identify an amount of data to prefetch in response to a local cache miss.

11. A compute platform comprising:
a System on a Chip (SoC) including a central processing unit (CPU) having one or more cores on which software is executed including one or more processes associated with applications, the SoC including a cache hierarchy comprising a local memory cache;
local memory coupled to the SoC; and
a network interface including one or more ports configured to be coupled to a network or fabric via which disaggregated memory in a remote memory pool is accessed;
wherein the compute platform is configured to:
execute, via a CPU core, a first memory transaction to access a first object;
determine the first object is not in the local memory cache, and in response,
determine a transaction abort is enabled for the first memory transaction; and
abort the first memory transaction.

12. The compute platform of claim 11, further configured to:
in response to the aborting the first memory transaction, identify the first object as a skipped object;
execute, via a CPU core, a second memory transaction to access a second object;
determine the second object is not in the local memory cache, and in response,
determine a transaction abort is enabled for the second memory transaction; and
abort the second memory transaction;
identify the second object as a skipped object; and
prefetch the first and second object from the remote memory pool.

13. The compute platform of claim 12, wherein the SoC is configured to generate a cache miss page fault when a memory access instruction references a memory address that is within a cacheable region registered for cache miss page faults, further comprising a page fault pooled memory handler, either embedded on the (SoC) or implemented in a discrete device coupled to the SoC, wherein the page fault pooled memory handler is configured to:
in response to the cache miss page fault,
implement a function or algorithm to generate one or more addresses of cache lines to prefetch from the remote memory pool.

14. The compute platform of claim 12, wherein the SoC includes further includes a memory type range register (MTTR) that is configured to store ranges of one or more cacheable regions of memory address space in the remote pooled memory for which a cache miss page fault may be generated when a memory access instruction references a memory address that is within a cacheable region.

15. The compute platform of claim 14, wherein a cache miss page fault may only occur in response to memory transactions attempting to access a cacheable region and for processes for which cache miss page faults are enabled.

16. A system on a chip (SoC), comprising:
a central processing unit (CPU) having a plurality of cores on which software is enabled to be executed including one or more processes associated with applications, each core having an associated level 1 (L1) cache and a level 2 (L2) cache;
a last level cache (LLC);
means for accessing memory in one or more memory tiers in which objects are stored;
an instruction set architecture including a set of one or more memory transactions instructions; and
logic for effecting at least one or a transaction abort and a cache miss page fault,
wherein the L1 caches, L2 caches, and the LLC comprise a local memory cache, and wherein the SoC is configured to:
execute, on a core of the plurality of cores, a first memory transaction to access a first object;
determine the first object is not in the local memory cache, and in response,
determine a transaction abort is enabled for the memory transaction; and
abort the memory transaction.

17. The SoC of claim 16, further configured to:
execute, on a core of the plurality of cores, a second memory transaction to access a second object;
determine the second object is not in the local memory cache, and in response,
determine a transaction abort is not enabled for the second memory transaction; and
access the second object from a memory tier in which the second object is stored.

18. The SoC of claim 16, further configured to:
in response to a memory access instruction referencing a cache line that is not in the local memory cache,
generate a cache miss page fault; and
provide an alert with an error code to an operating system running on the CPU.

19. The SoC of claim 18, wherein the one or more memory tiers comprises remote pooled memory, further comprising a page fault pooled memory handler configured to:
in response to a cache miss page fault,
implement a function or algorithm to generate one or more addresses of cache lines to prefetch from the remote pooled memory.

20. The SoC of claim 18, further comprising a memory type range register (MTTR) that is configured to store ranges of one or more cacheable regions of memory address space in one or more memory tiers for which a cache miss page fault may be generated when a memory access instruction references a memory address that is within a cacheable region.
